(19) United States
(12) Patent Application Publication
(10) Pub. No.: US 2008/0162706 A1
(43) Pub. Date: Jul. 3, 2008

(54) Interface Device

(75) Inventors: Mahendra Tailor, Middlesex (GB); Nicholas Hunn, Middlesex (GB)

Correspondence Address: BLAKELY SOKOLOFF TAYLOR & ZAFMAN, 1279 OAKMEAD PARKWAY, SUNNYVALE, CA, 94085-4040, US

(73) Assignee: Ezurio Limited, London (GB)

(21) Appl. No.: 11/993,969

(22) PCT Filed: Jun. 27, 2006
(86) PCT No.: PCT/GB2006/002362

§ 371 Date: Dec. 26, 2007

(30) Foreign Application Priority Data
Jun. 27, 2005 (GB) 0513052.1

(51) Int. Cl. G06F 15/16

(52) U.S. Cl. 709/228

(57) ABSTRACT

An interface device (10) for enabling wireless data communication between a host device (12) and a remote device (14) has a host serial interface (16) which is connected to the host device (12) and a wireless interface (18) for wireless data communication with the remote device (14). The interface device (10) also has a wireless interface controller (22) which is configured to control the operation of the wireless interface (18) to enable data communication between the host device (12) and remote device (14) via the interface device (10). A memory (26) in the interface device (10) stores a BASIC computer program and an interpreter (24) reads successive program commands from the memory (26) and converts the program commands into corresponding control commands for the wireless interface controller (22). The interface device (10) has the particular advantage that the same BASIC program may be used to operate interface devices using different wireless interface protocols simply by configuring the interpreter.

### FIELD OF THE INVENTION

The present invention relates to an interface device, and in particular to an interface device for wireless data communication.

### BACKGROUND TO THE INVENTION

WO 2004/017575 discloses Bluetooth serial adapters for conducting wireless communication between a host device and a remote device using the Bluetooth communications protocol. According to this document, the operation of the serial adapters can be controlled by a series of commands similar to the standard “AT” modem control commands originally developed by Hayes for the control of wired modems. Such control commands are at least partially familiar to programmers and therefore aid developers in controlling the serial adapter effectively.

However, even with the serial adapter disclosed in WO 2004/017575, the AT commands used to control the serial adapter operate at a level that is dependent on the wireless protocol used to communicate with the remote device. In addition to Bluetooth, there are several other common wireless protocols, such as ZigBee or Wi-Fi and it would be desirable for the control commands to a wireless interface to be independent of the protocol that is used for wireless communication.

### SUMMARY OF THE INVENTION

According to the present invention, there is provided an interface device for enabling wireless data communication between a host data processing device and a remote data processing device, the interface device comprising:
a host interface connectable to the host device to provide data communication between the interface device and the host device;
a wireless interface capable of wireless data communication with at least one remote device;
a wireless interface controller configured to control the operation of the wireless interface to enable data communication between the host interface and the wireless interface;
a memory arranged to store a computer program comprising a sequence of program commands in a first language; and
an interpreter configured to read successive program commands from the memory, to convert the program commands into corresponding control commands for the wireless interface controller and to communicate the control commands to the wireless interface controller for execution.

Thus, according to the present invention, the interface device has an on-board memory for storing a computer program and an interpreter for interpreting the computer program into control commands for the wireless interface controller. In this way, the interface device can store a computer program in a first language and process the program to operate the wireless interface without the need for the external control of a host computer, for example. Moreover, it is possible for the language and the content of the computer program to be independent of the hardware configuration of the interface device, because the interpreter can be configured to interpret the computer program to achieve the desired result with the particular hardware of the interface controller. Thus, the same computer program may control the operation of an interface device using a Bluetooth wireless interface or an interface using a ZigBee wireless interface, because the on-board interpreter is configured to convert the program commands to the correct control commands for the particular wireless interface controller. This is of great commercial significance in the field of wireless communication, because it means that a software developer need only create one computer program to handle wireless communication and that computer program can be used by a range of interface devices using different wireless communication protocols, provided that each has an appropriate interpreter in accordance with the invention. This significantly enhances the interoperability of wireless devices.

Thus, viewed from a further aspect, the invention extends to a plurality of interface devices as described herein, each comprising a wireless interface configured to operate in accordance with a different communication protocol, wherein the interpreter of each interface device is configured to be capable of interpreting the same computer program comprising a sequence of program commands in the first language. According to this aspect of the invention, a suite of interface devices may be produced each of which can be programmed in the same language, but each of which uses a different communications protocol, such as Bluetooth, ZigBee, Wi-Fi, IEEE 802.15.4, etc.

Typically, the interface device comprises a microprocessor. Conveniently, the microprocessor may be configured to operate as the wireless interface controller and the interpreter. For example, integrated circuits are known which include a microprocessor, memory, a radio transceiver and wireless baseband signal processing components. According to the invention, the microprocessor may be programmed to operate as an interpreter in addition to controlling the wireless interface. In this way, the invention may be implemented without additional hardware. Alternatively, an additional microprocessor may be provided to implement the interpreter.

Viewed from a further aspect, therefore, the invention extends to computer software which when run on a general purpose microprocessor configures the microprocessor to operate as an interpreter and a wireless interface controller for an interface device as herein described.

The language of the computer program may be any suitable interpreted language. An advantage of an interpreted language is that discrete program commands can be interpreted and actioned in sequence. Thus it is possible to run the computer program without interrupting other operations of the interface device. For example, where the interpreter and the wireless interface controller are provided by a single microprocessor, the microprocessor may be arranged to interpret program commands between instructions required by the operation of the wireless interface controller. In this way, the operation of the interpreter may be interleaved with the operation of the wireless interface controller on a single microprocessor. Such an arrangement allows the interpreter to run on the microcontroller without negatively affecting the wireless interface performance of the microprocessor.

The interpreter may be configured to process program commands from the memory while the wireless interface is in data communication with a remote device.

In particular, the interpreter may run in a virtual machine. In this case, the microprocessor may multitask with threads being used to control the baseband and radio at the same time as the interpreter operates. The interpreter should not interrupt the radio processing. However, the interpreter may run through scripts, for example filling arrays, testing loops, reading input/output, talking to the host interface at the same time as the wireless interface is operating. This feature may be implemented in a number of different ways, for example, using a virtual machine or a multithreaded, embedded operating system. In each case, the interpreter can run concurrently with the radio. This has the advantage that it allows data operations to be prepared at the same time as the radio is operating. For example, when the interface device is connected to a transducer the interpreter may run a program that calibrates and scales the transducer so that as soon as the radio becomes free this information can be sent over the radio link. This significantly reduces the latency of a single threaded approach, which in turn means that data can be sent more frequently, enhancing the duty cycle. This is particularly important with wireless standards such as Wi-Fi and ZigBee, where the data rate over the air can be in excess of 1 Mbps. Whereas the slow GPRS rates of 20 kbps to 40 kbps allow more time for processing between radio transmissions, the higher data rates of Bluetooth and Wi-Fi are best operated with concurrent processing.

A presently preferred language for the computer program is BASIC, as this is familiar to a wide range of programmers. However, other such high-level languages would also be suitable.

In addition to program commands that require conversion to control commands for the wireless interface controller, the computer program may include program flow commands that do not require conversion but are processed by the interpreter. Such program commands include program flow commands (for example to create loops, call subroutines or jump to other parts of the program), mathematical operations, conditional and logical statements and variable definitions. Thus, the interpreter may be configured to process program commands which have no direct effect on the operation of the wireless interface.

The memory may be volatile or non-volatile, for example flash memory. The computer program may be loaded into the memory via the host interface or the wireless interface. Alternatively, the computer program may be loaded directly into the memory during manufacture of the interface device.

The wireless interface may be configured to operate in accordance with any desired protocol. For example, the wireless interface may be a Bluetooth, ZigBee or Wi-Fi interface. However, the invention is not limited to short range communication protocols. Longer range communications protocols such as GSM or GPRS may also be used with appropriate wireless interfaces. It is also possible for the wireless interface to operate in accordance with multiple protocols or for the interface device to include multiple wireless interfaces.

The host interface may be any suitable interface. In particular, the host interface may be a serial interface, for example a USB interface. Typically the host interface is a wired interface. However, it is also possible for the host interface to be a wireless interface.

In general, the interface device is physically configured as a single unit. Thus, the interface device may comprise a housing which contains the host interface, wireless interface, wireless interface controller, memory and interpreter.

### BRIEF DESCRIPTION OF THE DRAWINGS

An embodiment of the invention will now be described by way of example only and with reference to the accompanying drawings, in which:

FIG. 1 is a schematic representation of an interface device according to an embodiment of the invention; and

FIG. 2 is a detailed schematic view of the architecture of an embodiment of the invention.

### DETAILED DESCRIPTION OF EXEMPLARY EMBODIMENTS

Figure is a schematic representation of an interface device 10 according to an embodiment of the invention. The interface device 10 is connected between a host device 12, shown in this case as a personal computer, and a remote device 14, shown in this case as a laptop computer.

The interface device comprises a host interface 16 and a wireless interface 18. The host interface 16 and the wireless interface 18 are in data communication with a microprocessor 20. The microprocessor 20 is configured to operate a wireless interface controller 22 for controlling the operation of the wireless interface 18 to facilitate data transfer between the host interface 16 and the wireless interface 18 and vice versa. The microprocessor 20 is further configured to operate as a BASIC interpreter 24 and to this end is in data communication with a memory 26 which is arranged to store one or more BASIC computer programs.

The host interface 16 in this embodiment is a serial interface in the form of a USB (universal serial bus) interface connected to the host computer 12 via a USB cable. The host computer 12 is able to send and receive data and control commands via this interface 16 for communication to the wireless interface controller 22, where the data is forwarded via the wireless interface 18 to the remote computer 14.

The wireless interface 18 in this embodiment is a Bluetooth interface. Thus, the wireless interface 18 includes a radio transceiver, baseband controller, link manager and host controller interface, in accordance with the Bluetooth specification. The higher level operations of the wireless interface 18 are controlled by the wireless interface controller 22 on the microprocessor 20.

The microprocessor 20 is also runs a BASIC interpreter 24, which reads BASIC commands from a computer program stored in the memory 26. Each BASIC command in the computer program is processed by the interpreter 24 and converted as necessary to control commands for the wireless interface controller 22, which are then processed by the wireless interface controller 22. In general, the computer program also includes program commands that do not require conversion to control commands. Such program commands may be program flow commands, conditional statements, variable definitions, mathematical operations and the like.

The BASIC interpreter 24 is configured to convert BASIC program commands into the appropriate control commands for wireless interface controller 22 dependent on the type of wireless interface used. In the present embodiment, the BASIC program commands are converted to control commands for the Bluetooth wireless interface 18. However, if the interface device 10 incorporates a ZigBee or Wi-Fi wireless interface 18, for example, the BASIC program commands are converted to control commands appropriate to the respective interface. This is a very significant feature of the invention in that the same BASIC program may be used to achieve the same functions independently of the wireless communication protocol used by the wireless interface 18. This significantly reduces the amount of work required by developers to configure software for operation with particular wireless protocols.

The table below shows some example program commands used by the BASIC interpreter 24 and the equivalent operations for each of the Bluetooth, ZigBee and Wi-Fi protocols.

| Command | Description | Bluetooth | ZigBee | Wi-FI |
|---|---|---|---|---|
| DISCOVER | Find available | Return list of discoverable | Return list of | Return list of |
| | resources | devices, may limit by | available nodes | Access Point |
| | | services, device type, | | SSIDs |
| | | friendly name, | | |
| | | manufacturer, etc | | |
| AUTHENTICATE | Set up secure | Pair device | Authenticate | Set up WEP/ |
| | link | | | WPA/AES/ |
| | | | | 802.11i |
| CONNECT | Open | Make connection to | Make connection | Connect to |
| | Connection, i.e. | device with Bluetooth | to device with | Access Point |
| | make an open | address | ZigBee address | with SSID |
| | bridge to the | | | |
| | UART/PCM | | | |
| | ports | | | |
| DISCONNECT | Break | Break connection | Break | Break |
| | connection | | connection or | connection |
| | | | remove from | |
| | | | mesh | |
| SENDFILE | Send an existing | FTP to a Bluetooth | Transfer data to | Send a file to an |
| | file | address | a node | IP address |
| GETFILE | Receive a file | Pull a file from a | Request data | Download a file |
| | | Bluetooth module (using | from a node | from an IP |
| | | OBEX or FTP) | | address |
| GETIO | Read status of | Read status of I/O, ADC, | Read status of | Read status of |
| | I/O | UART etc | I/O, ADC, | I/O, ADC, |
| | | | UART etc | UART etc |
| SET | General setting | Encryption, trusted, power | Routing, power | QoS, etc |
| | options, which | level, friendly name, etc | mode, etc | |
| | may be protocol | | | |
| | specific | | | |
| PING | Find a | Inquire for a specific | Return existence | Return |
| | connection | address and return status | of node and | connection |
| | | | routing | status of Access |
| | | | information | Point (PING |
| | | | | SSID) or remote |
| | | | | IP address |

With the interpreter 24 running on the same microprocessor 20 as the wireless interface controller 22, it is important that the operation of the controller 22 is not impeded by the operation of the interpreter 24. To prevent this, the interpreter 24 is configured to process the program commands of the computer program in sequence when there is available processing capacity from the microprocessor 20. Because the BASIC programming language uses a sequence of discrete commands, the microprocessor 20 can be configured such that the interpreter 24 processes one program command and then control of the microprocessor returns to the controller 22 to process any outstanding control commands. In this way the operation of the interpreter 24 is interleaved in time with the operation of the controller 22 by the microprocessor 20. Alternatively, the microprocessor 20 can be configured so that instructions from the controller 22 take precedence over instructions from the interpreter 24. The interpreter 24 may run in a virtual machine such that the interpreter 24 is multitasking with the threads being used to control the baseband and radio.

The interface device 10 according to this embodiment of the invention may be implemented using commercially-available hardware. For example, the BlueCore4-Ext Bluetooth device available from Cambridge Silicon Radio of Cambridge, United Kingdom incorporates a 2.4 GHz radio, baseband digital signal processing, random access memory, microprocessor and input/out control on a single-chip. Thus, the invention may be implemented on this chip by programming the microprocessor to run a BASIC interpreter in addition to the existing control of the Bluetooth wireless communication. The BlueCore4-Ext has an interface for an external flash memory which may be used in addition to the on-board RAM to store BASIC code in accordance with the invention.

Alternatively, the CC1010 integrated RF transceiver and microcontroller available from Chipcon AS of Oslo, Norway incorporates a 8051-compatible microprocessor, SRAM, flash memory and an RF transceiver on a single chip. This device may also be programmed to operate in accordance with the invention by programming the microprocessor to operate as both a BASIC interpreter and a wireless interface controller.

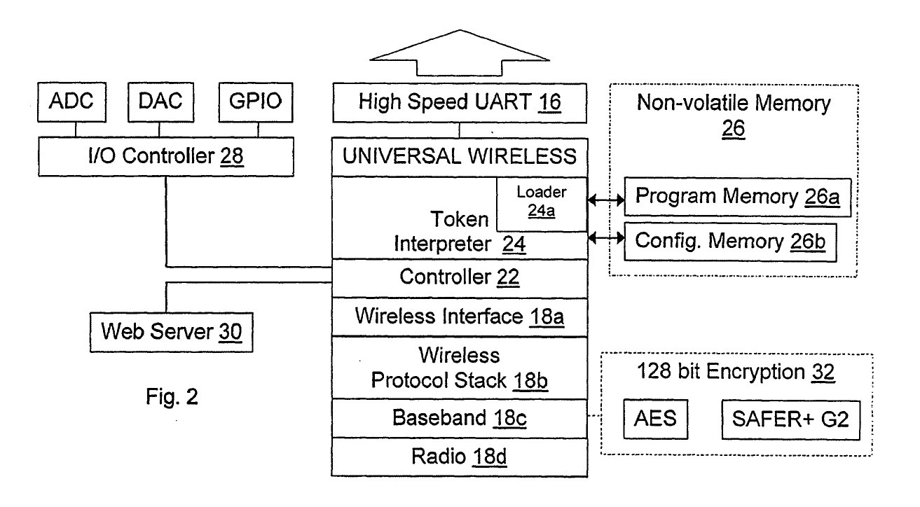

FIG. 2 shows a detailed schematic view of the architecture of an embodiment of the invention. In this embodiment, the host interface 16 is in the form of a high speed UART (universal asynchronous receiver transmitter) interface. However, the interface device also includes ADC (analogue to digital converter), DAC (digital to analogue converter) and GPIO (general purpose input output) interfaces which communicate with the wireless interface controller 22 via an input output controller 28. The interface device 10 of this embodiment also includes a web server 30 which is in direct data communication with the wireless interface controller 22.

The host device 12 communicates via the host interface 16 with a universal wireless layer that controls communications to the interpreter 24 and the controller 22. In this embodiment, the interpreter includes a token interpreter 24 and a loader 24a, which controls the loading of programs from the non-volatile memory 26 to the token interpreter 24. The non-volatile memory 26 includes a program memory 26a for storing programs for interpretation by the interpreter 24 and a configuration memory 26b for storing configuration data for the interpreter 24 and, optionally, for other components of the interface device 10.

In this embodiment, the wireless interface 18 comprises a wireless interface 18a for the wireless controller 22 as well as a wireless protocol stack 18b, a baseband processor 18c and a radio transceiver 18d. The baseband processor 18c is in data communication with a 128-bit encryption device 32 operating in accordance with the Advanced Encryption Standard (AES), Safe and Fast Encryption Routine (SAFER+) and the G2 standard.

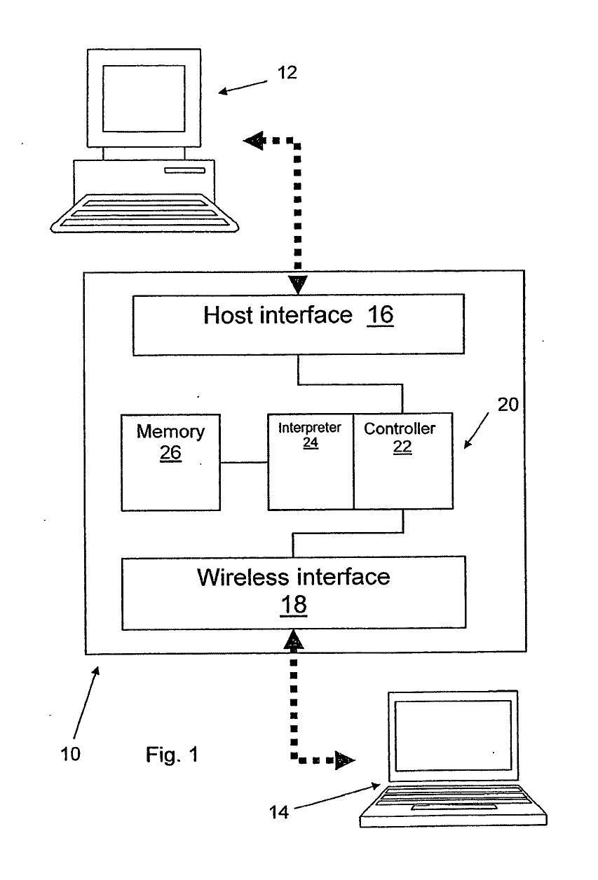

Although the host device 12 and remote device 14 have been shown as computers in FIG. 1, it is not necessary for these devices to have any significant onboard processing power to operate with the interface device 10 of the invention. It is only necessary that he host device has an interface that is compatible with the host interface 16, such as a USB port and that the remote device has an interface that is compatible with the wireless interface 18, such as a Bluetooth interface. Thus, the invention has many applications, such as data logging from embedded systems in vending machines, cars and the like.

An example application might be the case of a vending machine which an engineer visits with a PDA (personal digital assistant). According to the prior art, the engineer connects the PDA to a serial port on the vending machine and runs a program on the PDA to download data. Using the interface device of the invention with a Wi-Fi wireless interface, say, the download program can be replicated as a script in the memory of the interface device together with the details of making a Wi-Fi connection. The host interface of the interface device is connected to the existing serial port of the vending machine. When the interface device powers up, it connects to a remote IP address using a local Wi-FI access point and goes into a standby mode. The download program can either be triggered by an internal timer in the in the interface device, or remotely from the internet. At which point the data is downloaded and sent to a remote monitoring program which logs it. The important point is that no changes need to be made to the vending machine—all that is required is to attach the interface device to the serial port. The module is in effect a remote, self-contained data logger that fully emulates the engineer's PDA.

Further applications include: credit card readers that support multiple radio interface options so that the radio interface can be chosen at final assembly; peripherals, such as “processor-free” modem boxes or “processor-free” keypads; cable replacement by providing pre-configured wireless adaptors for legacy ports; personal medical monitors; simple connections for medical diagnostic equipment to hospital networks and PDAs; automotive on board diagnostics; and in-car entertainment (mobile phone connectivity and Bluetooth audio connectivity).

The programs run by the interpreter may be used to implement wireless-specific interface protocols within the interface device, such as controller area network (CAN), local interconnect network (LIN) and IEEE 1451.5 protocols. This capability is of particular significance in the context of transducer interfacing, telemetry for modem interfacing and automotive diagnostics. Thus, the memory may store a library of application protocols, for example using transducer electronic datasheets (TEDS) for conversion between IEEE 1451.5 protocols and IEEE 1451.0 protocols, in accordance with the network capable applications processor (NCAP) or the wireless transducer interface model (WTIM).

In summary, an interface device for enabling wireless data communication between a host device and a remote device has a host serial interface which is connected to the host device and a wireless interface for wireless data communication with the remote device. The interface device also has a wireless interface controller which is configured to control the operation of the wireless interface to enable data communication between the host device and remote device via the interface device. A memory in the interface device stores a BASIC computer program and an interpreter reads successive program commands from the memory and converts the program commands into corresponding control commands for the wireless interface controller. The interface device has the particular advantage that the same BASIC program may be used to operate interface devices using different wireless interface protocols simply by configuring the interpreter.

1. An interface device for enabling wireless data communication between a host data processing device and a remote data processing device, the interface device comprising:
a host interface connectable to the host device to provide data communication between the interface device and the host device;
a wireless interface capable of wireless data communication with at least one remote device;
a wireless interface controller configured to control the operation of the wireless interface to enable data communication between the host interface and the wireless interface;
a memory arranged to store a computer program comprising a sequence of program commands in a first language; and
an interpreter configured to read successive program commands from the memory, to convert the program commands into corresponding control commands for the wireless interface controller and to communicate the control commands to the wireless interface controller for execution.

2. An interface device as claimed in claim 1, wherein the interface device comprises a microprocessor and the microprocessor is configured to operate as both the wireless interface controller and the interpreter.

3. An interface device as claimed in claim 1, wherein the interpreter is further configured to process program commands from the computer program which have no direct effect on the operation of the wireless interface.

4. An interface device as claimed in claim 1, wherein the interpreter is configured to process program commands from the memory while the wireless interface is in data communication with a remote device.

5. Computer software which when run on a general purpose microprocessor configures the microprocessor to operate as an interpreter and a wireless interface controller for an interface device as claimed in claim 1.

6. A plurality of interface devices as claimed in claim 1, wherein each interface device comprises a wireless interface configured to operate in accordance with a different communication protocol, and wherein the interpreters of all of the interface devices are capable of interpreting the same computer program in the first language.
